(19) United States
(12) Patent Application Publication
(10) Pub. No.: US 2005/0088747 A1
(43) Pub. Date: Apr. 28, 2005

(54) Gauge glare and reflection reduction system and method

(76) Inventor: Johnny L. Knight, Asheville, NC (US)

Correspondence Address: J. DEREL MONTEITH, JR.;CARTER, SCHNEDLER & MONTEITH, P.A., 56 CENTRAL AVENUE, SUITE 101, P.O. BOX 2985, ASHEVILLE, NC, 28802, US

(21) Appl. No.: 10/692,162

(22) Filed: Oct. 23, 2003

(51) Int. Cl. G02B 6/00

(52) U.S. Cl. 359/601

(57) ABSTRACT

A gauge glare and reflection reduction system including a gauge comprising a face, a panel through which the face of the gauge may be viewed, and a tinting element configured for placement on the panel.

### BACKGROUND OF THE INVENTION

Light sources that illuminate the faces of motor vehicle gauges such as speedometers, tachometers, fuel level gauges, temperature gauges, and oil pressure gauges in cars, trucks, sport utility vehicles, motorcycles, tractors or cabs for tractor-trailers, and other motor vehicles may, when activated, cause unwanted glare and reflections on other surfaces in a motor vehicle, such as, for instance, windshields. This glare and any associated reflections may distract a motor vehicle operator from optimally performing the critical task of ensuring continuously safe operation of the vehicle.

### BRIEF DESCRIPTION OF THE DRAWINGS

FIG. 1 is a perspective view of a gauge glare and reflection reduction system according to an embodiment of the invention;

FIG. 2 is an exploded view of a gauge glare and reflection reduction system according to an embodiment of the invention; and

FIG. 3 is a perspective view of an embodiment of a sheet of tinting material that may be used in an embodiment of the invention.

### DETAILED DESCRIPTION OF THE INVENTION

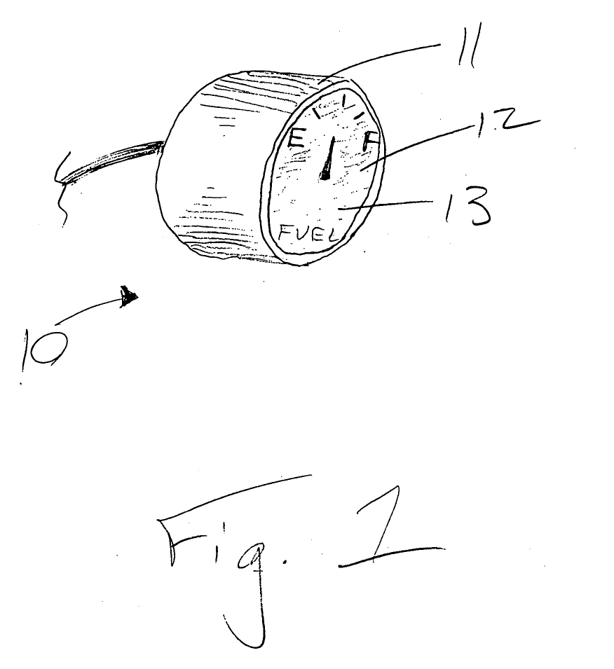

A gauge glare and reflection reduction system according to an embodiment of the invention is illustrated broadly in FIG. 1 at reference numeral 10. The system 10 includes a gauge 11 comprising a face 12 and a panel 13 through which the face 12 of the gauge 11 may be viewed. The gauge 11 may be incorporated into a motor vehicle (not shown) such as a car, truck, sport utility vehicle, motorcycle, or tractor or cab for a tractor-trailer, and may be any one of a variety of types of gauges, including, without limitation, a speedometer, a tachometer, a fuel level gauge (as shown), a temperature gauge, or an oil pressure gauge. The panel 13 of the gauge 11 is tinted to help reduce unwanted glare and reflections caused by a light source (not shown) that, when activated, illuminates the face 12 of the gauge 11 and projects light through the panel 13. The panel 13 may be tinted by one or more of a variety of means. For instance, the panel 13 or a portion thereof may be coated or treated with dye, pigment, coloring, or shading that tints at least a portion of the panel 13, and/or a tinting element such as a sheet of window tinting material of appropriate dimensions may be applied to the panel 13.

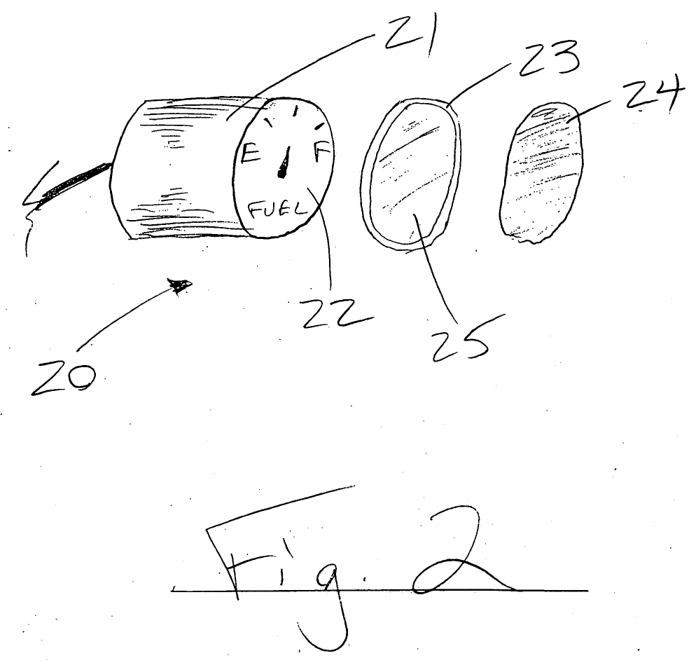

FIG. 2 illustrates an embodiment of the system in which latter of the above panel tinting means, the tinting element, is utilized as the only panel tinting means. Looking at FIG. 2, an embodiment of a gauge glare and reflection reduction system 20 is shown. The system 20 comprises a gauge 21 with a face 22, a panel 23 for mounting on the gauge 21 and through which the face 22 of the gauge 21 may be viewed, and a tinting element 24 for placing on an external surface 25 of the panel 23. The tinting element 24 may alternatively be placed on an internal surface (not shown) of the panel 23. As another alternative, the tinting element 24 on the external surface 25 of the panel 23 may be supplemented with a second tinting element (not shown) placed on an internal surface (not shown) of the panel 23, resulting in simultaneous use of an internal tinting element (not shown) and the external tinting element 24. Although the system 20 shown in FIG. 2 illustrates the gauge 21 and the panel 23 as physically separable elements, the gauge 21 and the panel 23 may alternatively be a unitary element or the panel 23 may otherwise be designed not to be removed from the gauge 21.

The tinting element 24 in this embodiment may be a sheet of window tinting material such as the material commonly marketed in do-it-yourself motor vehicle window tinting kits or as stand-alone do-it-yourself motor vehicle window tinting products, as known by those of ordinary skill in the art. Manufacturers and/or marketers of such tinting material include Sun-Gard Solar Control Products of St. Petersburg, Fla.; MSC Specialty Films, Inc. of Clearwater, Fla. (SOLARGARD window films); Johnson Window Films, Inc. of Carson, Calif.; and Avery Dennison Corporation of London, Ontario, Canada (TRIMBRITE window tinting). The tinting material is fabricated using methods and materials known by those of ordinary skill in the art. Typical materials used to fabricate the tinting material are plastic and vinyl. The tinting material may be produced in one or more of a variety of colors, including black, gray, and non-monochrome colors that may be designed and/or selected to match, complement, or contrast with the colors of the vehicle. Furthermore, the tinting material may be pre-cut in dimensions to fit gauge panels having a full range of dimensions.

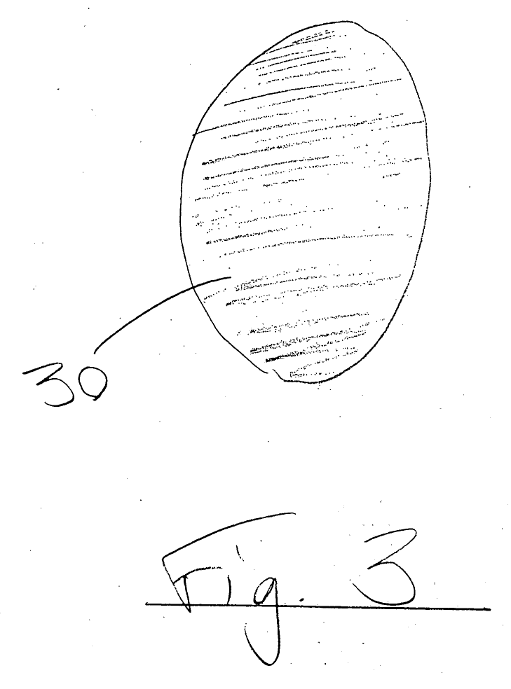

FIG. 3 illustrates a pre-cut sheet 30 of tinting material configured for placement on a panel of a gauge. Such a sheet 30 may be fabricated by determining the desired dimensions of the sheet 30 and obtaining a sheet 30 having the desired dimensions, for instance by fabricating such a sheet in the first instance or by cutting a sheet having the desired dimensions from a larger sheet (not shown) of tinting material. The pre-cut sheet 30 of tinting material may then be placed on a surface of a gauge panel, as shown and discussed in conjunction with FIG. 2.

Embodiments of the invention are particularly effective in motor vehicles having gauges with light sources oriented such that they may cause unwanted glare and reflection on other surfaces in such vehicles, such as windshields or other windows. Such motor vehicles include, without limitation, motorcycles.

A gauge glare and reflection reduction system and method is described above. Various details of the invention may be changed without departing from its scope. Furthermore, the foregoing description of an embodiment of the invention and the best mode for practicing the invention are provided for the purpose of illustration only and not for the purpose of limitation-the invention being defined by the claims.

1. A gauge glare and reflection reduction system, comprising:
a gauge comprising a face;
a panel through which the face of the gauge may be viewed; and
a tinting element configured for placement on the panel.

2. A gauge glare and reflection reduction system according to claim 1, wherein the tinting element is a sheet of window tinting material.

3. A gauge glare and reflection reduction system according to claim 2, wherein the window tinting material is designed for use on motor vehicle windows.

4. A gauge glare and reflection reduction system according to claim 1, wherein the gauge is on a motorcycle.

5. A gauge glare and reflection reduction system, comprising:
a gauge comprising a face;
a tinted panel through which the face of the gauge may be viewed.

6. A gauge glare and reflection reduction system according to claim 5, wherein the gauge is on a motorcycle.

7. A gauge glare and reflection reduction system, comprising:
a gauge comprising a face;
a panel through which the face of the gauge may be viewed; and
means for tinting the panel.

8. A gauge glare and reflection reduction system according to claim 7, wherein the gauge is on a motorcycle.

9. A gauge glare and reflection reduction system, comprising:
a motorcycle;
a gauge on the motorcycle, said gauge comprising a face;
a panel through which the face of the gauge may be viewed; and
a tinting element configured for placement on the panel.

10. A gauge glare and reflection reduction system according to claim 9, wherein the tinting element is window tinting material.

11. A gauge glare and reflection reduction system according to claim 10, wherein the window tinting material is designed for use on motor vehicle windows.

12. A gauge glare and reflection reduction system, comprising:
a motorcycle;
a gauge on the motorcycle, said gauge comprising a face; and
a tinted panel through which the face of the gauge may be viewed.

13. A gauge glare and reflection reduction system, comprising:
a motorcycle;
a gauge on the motorcycle, said gauge comprising a face;
a panel through which the face of the gauge may be viewed; and
a sheet of window tinting material configured for placement on the panel.

14. A gauge glare and reflection reduction system according to claim 13, wherein the window tinting material is designed for use on motor vehicle windows.

15. A method for reducing glare and reflections associated with a gauge, said method comprising the steps of:
providing a gauge comprising a face;
providing a panel through which the face of the gauge may be viewed;
providing a tinting element;
placing the tinting element on the panel.

16. A method for reducing glare and reflections associated with a gauge according to claim 15, wherein the tinting element in said tinting element providing step and said placing step comprises a sheet of window tinting material configured for placement on the panel.

17. A method for reducing glare and reflections associated with a gauge according to claim 16, wherein the window tinting material comprising the tinting element in said tinting element providing step and said placing step is designed for use on motor vehicle windows.

18. A method for reducing glare and reflections associated with a gauge according to claim 15, wherein said tinting element providing step is performed by determining dimensions of the tinting element and obtaining a sheet of window tinting material having the determined dimensions to form the tinting element.

19. A method for reducing glare and reflections associated with a gauge according to claim 18, wherein the window tinting material comprising the tinting element in said tinting element providing step and said placing step is designed for use on motor vehicle windows.
